(19) United States
(12) Patent Application Publication
(10) Pub. No.: US 2015/0052761 A1
(43) Pub. Date: Feb. 26, 2015

(54) CUTTING TOOL

(71) Applicant: Werkzeugfabrik Albert Krenn e. K., Neusass (DE)

(72) Inventor: Thomas JÄGER, Neusass (DE)

(21) Appl. No.: 14/461,627

(22) Filed: Aug. 18, 2014

(30) Foreign Application Priority Data
Aug. 21, 2013 (DE) 10 2013 109 023.0

(51) Int. Cl. B23D 29/00

(52) U.S. Cl. CPC B23D 29/002
USPC 30/179; 30/233

(57) ABSTRACT

A cutting tool for the cutting of strands with a holding area for the strand, a cutting blade that can be moved in, perpendicular to the course of the strand, into this holding area, and a stop that lies opposite the cutting blade. Such known cutting tools have the disadvantage that they function unreliably when cutting wire ropes and stranded wires. The disclosed cutting tool is designed better for the cutting of wire ropes, stranded wires, and other strands, and has a tubular guiding device for the strand, which follows the holding area and is firmly connected to the cutting tool.

### FIELD OF THE DISCLOSURE

The disclosure relates to a cutting tool.

### BACKGROUND OF THE DISCLOSURE

Such cutting tools, frequently also designated as cutting heads, are used for the cutting of mostly cylindrical or longitudinal metal parts, for example, bolts, threaded rods, rods, or tubes. They have a cutting blade, which can be moved into a holding space for the material to be cut, that is supported on a stop located opposite the cutting blade. Another cutting blade is located on the stop; the blade is shaped in accordance with the cross section of the track and, in addition, guides it and interacts, in the manner of shears, with the cutting blade that can be moved in. The actuation of such cutting tools or cutting heads is, as a rule, carried out electrically, hydraulically, or electro-hydraulically, since the considerable forces for the cutting of thicker metal bolts or rods can be produced only through mechanical reinforcement. The publication DE 229313 shows a device for advancing rod-like bodies with correlated shears to cut off pieces of these rod-like bodies. The device is suitable only for rod-like bodies. A special guide for these bodies is not provided.

Furthermore, the publication AT 387352 B shows a portable cutting device for the burr-free, right-angled cutting off of rods, and DE 10 2010 061 191 A1, a method for the severance of tubes and a corresponding device. Finally, U.S. Pat. No. 1,769,001 shows a cutting device for cables.

Known cutting devices, as they can be deduced, in part, from the publications mentioned above, have the disadvantage that they function unreliably when cutting wire ropes, stranded wires, or any materials composed of many individual elements, which are designated in this description and in the claims as strands, since the individual elements of the strands can tilt against one another and relative to the cutting direction and can slip out of the holding space, so that a clean cut is not possible or the firm cutting blade is destroyed. For the cutting of such strands, which are used in the form of tension steel cables and wires to absorb tensile forces in construction works, above all, in the construction of towers of wind power stations, it is therefore necessary to use so-called angle grinders and cut through the strands. This has, in turn, the disadvantage of flying sparks and the evaporation of oil and grease layers on the strands, which results in endangering workers because of the sparks and the toxic gases and considerable smoke formed during the evaporation of the grease layers.

### SUMMARY OF THE DISCLOSURE

An embodiment of the disclosure teaches a cutting tool that is more suitable for the cutting of strands. The disclosure also teaches other features of cutting tools.

### BRIEF DESCRIPTION OF THE DRAWINGS

An embodiment example of the disclosure is explained in more detail below, with reference to the accompanying drawings. The figures show the following:

FIG. 1: A perspective representation of the cutting tool before inserting the guiding device;

FIG. 2: a cross section along the axis of the guiding device, as viewed from direction A from FIG. 1;

FIG. 3: a representation in accordance with FIG. 1, with the axis of the guiding device 4 in the plane of the drawing;

FIG. 4: a representation in accordance with FIGS. 1 and 2, with the axis of the guiding device 4 perpendicular to the plane of the drawing;

FIG. 5: a representation in accordance with FIG. 1, with an inserted guiding device;

FIG. 6: a cross section along the axis of the guiding device, as viewed from direction A from FIG. 5;

FIG. 7: a representation in accordance with FIG. 5, with the axis of the guiding device in the plane of the drawing;

FIG. 8: a representation in accordance with FIGS. 5 and 7, with the axis of the guiding device perpendicular to the plane of the drawing.

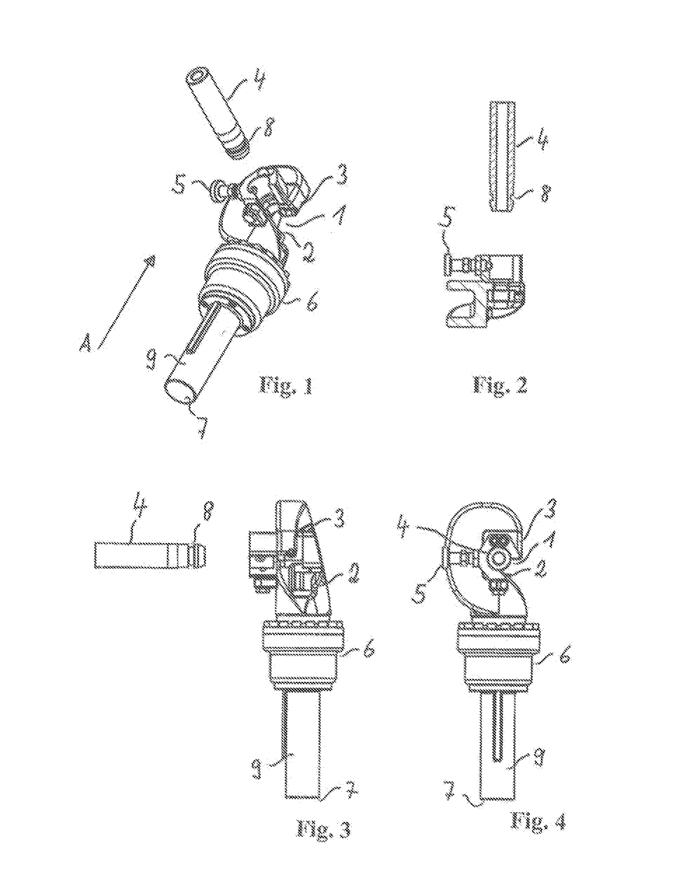

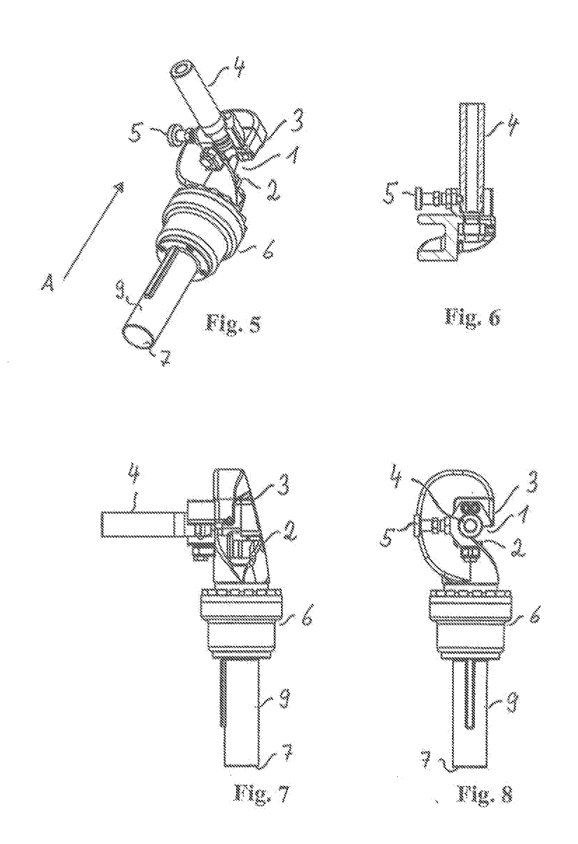

In all the figures, one and the same cutting tool is shown from various perspectives and immediately before the insertion of a guiding device (FIGS. 1-4) or with the inserted guiding device (FIGS. 5-8).

### DETAILED DESCRIPTION OF THE DISCLOSURE

The cutting device shown includes of a housing, which is also designated as a cylinder 6, with a central axis running in direction A, shown in FIGS. 1 and 5, by means of which the impingement of the cutting tool with the hydraulic fluid also takes place. Via the inlet 7 of the holding tube 9 of the cylinder 6, following the central axis, the connection of the cutting tool, via hose connections (not shown), to a hydraulic pump (also not shown) takes place. On the side of the cylinder 6, opposite this inlet 7 of the holding tube 9, you find the cutting blade 2, which can be moved in and which is designed so it can be replaced and is made of a very hard material, in particular, hardened steel. The cutting blade 2, hydraulically actuated, can be moved in and out in the direction of the central axis A of the cylinder 6, wherein the moving out of the cutting blade 2 implies a movement in the direction of the holding space 1, provided for the holding of the material to be cut. This holding space 1 is followed by a stop 3, which is designed in the shape of a C or a U and has an additional molding (not depicted) to hold the strand to be cut, and a lateral accessibility of the holding space 1 is made possible. The stop 3 has a second, firm cutting blade, against which the cutting blade 2 that can be moved in makes a shearing movement when it is moved in the direction of the material to be cut and beyond. The stop 3 also fixes the material to be cut relative to the cutting blade 2.

In the cutting tool shown, a tubular guiding device 4 follows the holding area 1; it can be connected to the cutting tool via a lock pin connection 5. In FIGS. 1-4, the arrangement of the guiding device relative to the cutting tool, in the sense of an exploded view, is shown; the guiding device 4 is therefore not yet connected to the cutting tool, but rather is shown immediately before the insertion into the cutting tool. The guiding device 4 has a tubular shape and is preferably made of metal. It has a groove 8, via which a clamping screw of the cutting tool meshes with the cutting tool after insertion of the guiding device 4, so that the guiding device 4 is firmly connected, in a form-locking manner, with the cutting tool. This state is shown in FIGS. 5-8.

As can be deduced from the figures, the axis of the tubular guiding device 4 is situated perpendicular to the central axis A of the cylinder 6 and thus also perpendicular to the movement of direction of the cutting blade 2. The guiding device 4 ends, in the incorporated state, before the cutting plane of the cutting blade 2 and the firm cutting blade on the stop 3.

To operate the cutting tool, this is positioned, as a rule, on a stand (not depicted), which can be adjusted in height and is adjusted to the desired length of the remaining wire ends (if they run vertically, via a concrete tower). Subsequently, the cutting tool is positioned roughly, relative to the wires to be cut or to the strand to be cut. Then, the guiding device 4, which has been released by then, is stuck on the strand to be cut and subsequently (that is, with the inserted strand), is connected to the cutting tool, using the lock pin connection 5. This operation can be carried out almost blind, which, given the lighting conditions at a construction site, such as in a basement or wind power station, is advantageous.

After the guiding device 4 has been again inserted into the cutting tool with the strand running through, the strand runs along the axis of the guiding device 4 and thus exactly perpendicular to the direction of movement A of the cutting blade 2. Then, the cutting blade 2 is hydraulically moved out to the strand to be cut or in the direction of the stop 3 of the cutting tool and cuts through the strand. As a result of the guiding of the strand within the guiding device 4, any tilting is avoided. A clean orthogonal cut through the strand takes place and the danger of damaging or breaking the cutting blade 2 is avoided or at least greatly reduced.

The cutting tool in accordance with the disclosure can be actuated in some other manner, for example, pneumatically or manually. Furthermore, other materials, especially composite materials, can also be used for the cutting head and also for the guiding device. Moreover, it is possible to connect the guiding device rigidly to the cutting tool, which then requires another handling and, in particular, is possible if the cutting tool is guided manually and is not positioned on a stand.

What is claimed is:

1. Cutting tool for the cutting of strand with a holding area for the strand, a cutting blade that can be moved into this holding area and is perpendicular to the course of the strand, and a stop lying opposite the cutting blade, wherein a guiding device for the strand, which follows the holding area and is firmly connected to the cutting tool.

2. Cutting tool according to claim 1, wherein the cutting blade can be moved out by hydraulic actuation.

3. Cutting tool according to claim 1, wherein the guiding device (4) is built as a metal tube, which is detachably connected to the cutting tool.

4. Cutting tool according to claim 3, wherein the connection between the metal tube and the cutting tool is brought about by an elastic lock pin.

5. Cutting tool according to claim 1, wherein the stop has another cutting blade, which shears with the cutting blade that can be moved in.

6. Cutting tool according to claim 2, wherein the guiding device is built as a metal tube, which is detachably connected to the cutting tool.

7. Cutting tool according to claim 6, wherein the connection between the metal tube and the cutting tool is brought about by an elastic lock pin.

8. Cutting tool according to claim 7, wherein the stop has another cutting blade, which shears with the cutting blade that can be moved in.

9. Cutting tool according to claim 2, wherein the stop has another cutting blade, which shears with the cutting blade that can be moved in.

10. Cutting tool according to claim 3, wherein the stop has another cutting blade, which shears with the cutting blade that can be moved in.

11. Cutting tool according to claim 4, wherein the stop has another cutting blade, which shears with the cutting blade that can be moved in.
